(19) United States
(12) Patent Application Publication
(10) Pub. No.: US 2014/0223380 A1
(43) Pub. Date: Aug. 7, 2014

(54) IMAGE PROCESSING APPARATUS, METHOD OF CONTROLLING THE SAME, AND STORAGE MEDIUM

(71) Applicant: Canon Kabushiki Kaisha, Tokyo (JP)

(72) Inventor: Toru Ikeda, Kawasaki-shi (JP)

(73) Assignee: CANON KABUSHIKI KAISHA, Tokyo (JP)

(21) Appl. No.: 14/169,187

(22) Filed: Jan. 31, 2014

(30) Foreign Application Priority Data
Feb. 5, 2013 (JP) 2013-020830

(51) Int. Cl. G06F 3/0481

(52) U.S. Cl. CPC G06F 3/04812
USPC 715/856

(57) ABSTRACT

An image processing apparatus being capable of transmitting image data of a screen displayed on a display unit of the image processing apparatus to an information processing apparatus with a VNC, and method of controlling the same are disclosed. The image processing apparatus establishes a connection with the information processing apparatus with the VNC, and combines a cursor image with image data of the screen being displayed on the display unit in a case that the connection with the information processing apparatus has been established. When an input event that is transmitted from the information processing apparatus in response to an operation of a pointing device on the information processing apparatus is receive, the apparatus updates image data, in which the cursor image is combined, that is being displayed on the screen based on the received event.

### BACKGROUND OF THE INVENTION

1. Field of the Invention

The present invention relates to an image processing apparatus, method of controlling the same, and storage medium.

2. Description of the Related Art

As how to use products and how to cope with troubles become complicated, customers frequently directly call a call center of a manufacturer to obtain answers to how to use, how to cope with troubles, and the like. In order to cope with such troubles appropriately and quickly, for example, Japanese Patent Laid-Open No. 2005-115756 has proposed a support system which directly logs in to a terminal of a user from a remote place and changes settings of an environment of the user.

Also, recently, using VNC (Virtual Network Computing), it is possible to display a desktop screen of a certain computer on another computer and to operate the screen via a network. Using this technique, for example, an operator of a call center can remotely control an apparatus of a customer to do maintenance of the apparatus and to support user operations. When the operator of the call center remotely operates an apparatus of a customer, an operation trace is shown using a cursor or the like so as to be able to plainly explain the operation procedure of that apparatus to the customer.

However, in case of an information processing apparatus such as an image processing apparatus which does not always display a cursor, when an operation method, setting method, or the like of the apparatus is to be explained from a remote place, since it is difficult for the user to recognize which button is pressed to make an operation, the operation procedure cannot often be correctly taught.

### SUMMARY OF THE INVENTION

An aspect of the present invention is to eliminate the above-mentioned problems with the conventional technology.

A feature of the present invention is to provide a technique for explaining an operation method, setting method, or the like of an image processing apparatus which does not always display a cursor while showing an operation trace using the cursor for the user of an information processing apparatus.

According to an aspect of the present invention, there is provided an image processing apparatus being capable of transmitting image data of a screen displayed on a display unit of the image processing apparatus to an information processing apparatus with a Virtual Network Computing (VNC), the apparatus comprising: a connection unit configured to establish a connection with the information processing apparatus with the VNC;a composite unit configured to combine a cursor image with image data of the screen being displayed on the display unit in a case that the connection unit has established the connection with the information processing apparatus; a reception unit configured to receive an input event that is transmitted from the information processing apparatus in response to an operation of a pointing device on the information processing apparatus; and an updating unit configured to update image data, in which the cursor image is combined, that is being displayed on the screen based on the event received by the reception unit.

According to an aspect of the present invention, there is provided a method of controlling an image processing apparatus being capable of transmitting image data of a screen displayed on a display unit of the image processing apparatus to an information processing apparatus with a Virtual Network Computing (VNC), the method comprising: establishing a connection with the information processing apparatus with the VNC; combining a cursor image with image data of the screen being displayed on the display unit in a case that the connection with the information processing apparatus has been established; receiving an input event that is transmitted from the information processing apparatus in response to an operation of a pointing device on the information processing apparatus; and updating image data, in which the cursor image is combined, that is being displayed on the screen based on the event received in the receiving step.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 depicts an overall view of an information processing system according to an embodiment of the present invention;

FIG. 2 is a block diagram showing the hardware arrangement of an image processing apparatus according to the embodiment of the present invention;

FIG. 3 is a block diagram showing the software arrangement of the image processing apparatus according to the embodiment of the present invention;

FIG. 4 is a flowchart for describing processing of the image processing apparatus according to the embodiment of the present invention; and

FIGS. 5A and 5B depict views showing examples of main menu screens displayed on a display unit of a console unit based on display information stored in the image processing apparatus according to the embodiment.

### DESCRIPTION OF THE EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

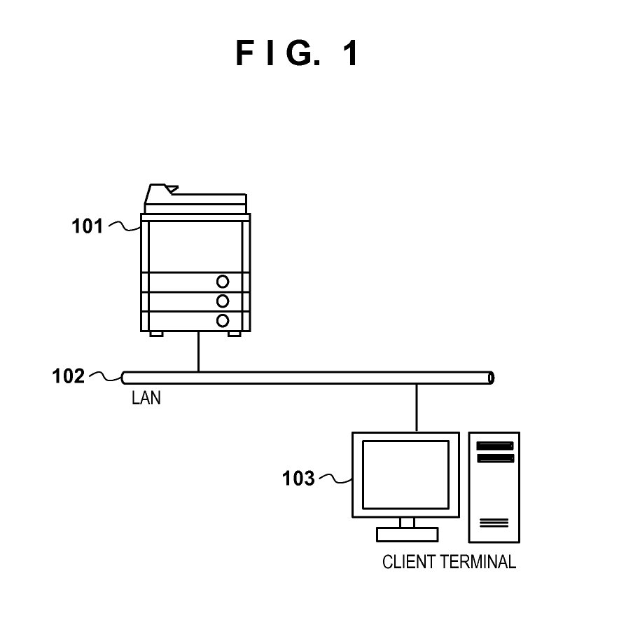

FIG. 1 depicts an overall view of an information processing system according to an embodiment of the present invention.

Referring to FIG. 1, an image processing apparatus 101 is VNC-connected to a client terminal 103 via a LAN 102. Also, the image processing apparatus 101 functions as a VNC server (an output side of the contents of a VRAM) as an information processing apparatus, and the client terminal 103 functions as a VNC client, that is, it receives and displays the contents of the VRAM (video memory) of the image processing apparatus 101.

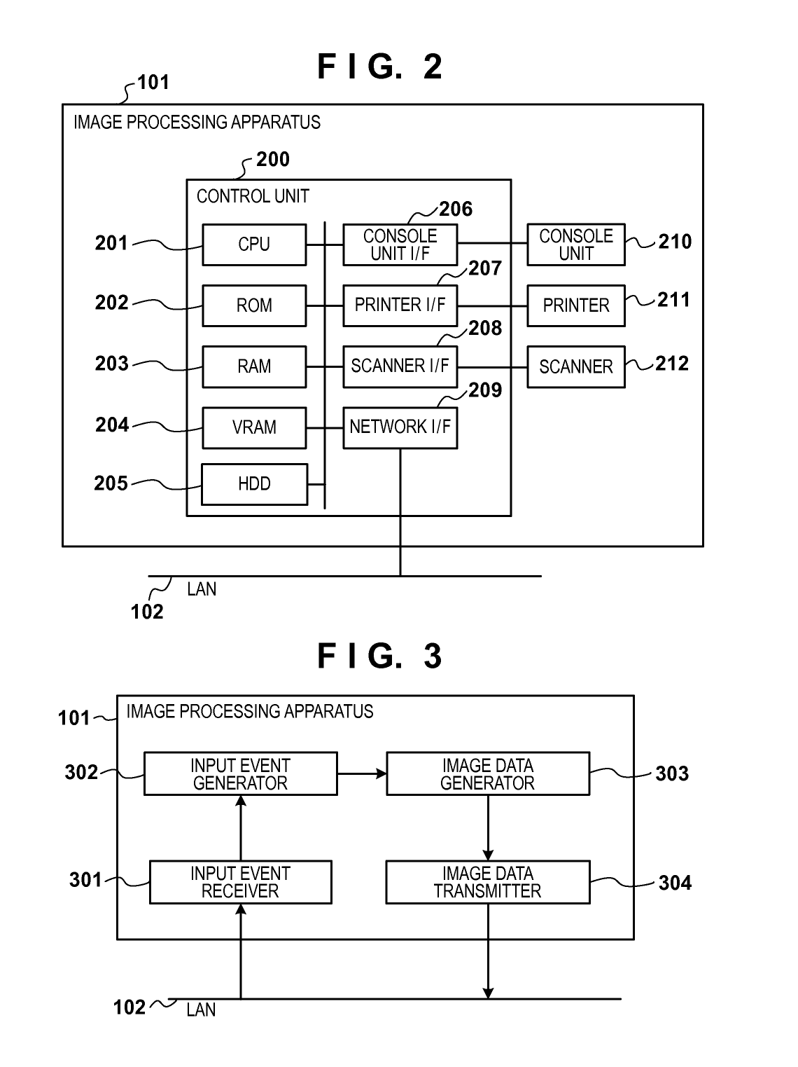

FIG. 2 is a block diagram showing the hardware arrangement of the image processing apparatus 101 according to the embodiment of the present invention.

A control unit 200 including a CPU 201 controls the operation of the overall image processing apparatus 101. Based on a boot program stored in a ROM 202, the CPU 201 reads out an OS and control programs installed in an HDD 205, deploys them onto a RAM 203, and executes various kinds of control such as reading control and transmission control according to the programs. The RAM 203 is used as temporary storage areas such as a main memory and work area of the CPU 201. Also, the RAM 203 is used as a storage area used to temporarily store screen information as a virtual RAM. A VRAM (Video RAM) 204 is a storage area which holds screen information written from the virtual RAM area of the RAM 203. Note that a partial area of the RAM 203 may be used as the VRAM 204. The HDD (Hard Disk Drive) 205 stores image data, various programs, or various kinds of information tables.

A console unit interface (I/F) 206 connects a console unit 210 and the control unit 200. The console unit 210 includes a display unit having a touch panel function, a keyboard, and the like. The console unit 210 displays an image on the display unit based on screen information held in the VRAM 204. A printer I/F 207 connects a printer 211 and the control unit 200. Image data to be printed by the printer 211 is transferred from the control unit 200 to the printer 211 via the printer I/F 207, and is printed on a printing medium (sheet) by the printer 211. A scanner I/F 208 connects a scanner 212 and the control unit 200. The scanner 212 reads an image on an original to generate image data, and inputs the image data to the control unit 200 via the scanner I/F 208. A network I/F 209 connects the control unit 200 to the LAN 102. The network I/F 209 transmits image data and information to an external apparatus on the LAN 102 and receives various kinds of information from the external apparatus on the LAN 102.

FIG. 3 is a block diagram showing the software arrangement of the image processing apparatus 101 according to this embodiment. Note that respective modules shown in FIG. 3 are implemented when the CPU 201 included in the image processing apparatus 101 reads out control programs stored in the HDD 205 onto the RAM 203 and executes the readout programs.

The image processing apparatus 101 includes an input event receiver 301, input event generator 302, image data generator 303, and image data transmitter 304. Using the input event receiver 301, the CPU 201 receives an input event signal transmitted from the client terminal 103 via the LAN 102, and holds it in the RAM 203. Using the input event generator 302, the CPU 201 generates an input event signal for the image processing apparatus 101 based on the input event signal received by the input event receiver 301, and sends it to the image data generator 303. Using the image data generator 303, upon reception of the input event signal, the CPU 201 generates screen information which reflects the contents of the input event signal, and holds the screen information in the virtual VRAM area of the RAM 203. Using the image data transmitter 304, the CPU 201 transmits the screen information held in the virtual VRAM area of the RAM 203 to the client terminal 103 via the LAN 102. Note that the screen information which is written from the virtual VRAM area of the RAM 203 and is held in the VRAM 204 may be transmitted to the client terminal 103.

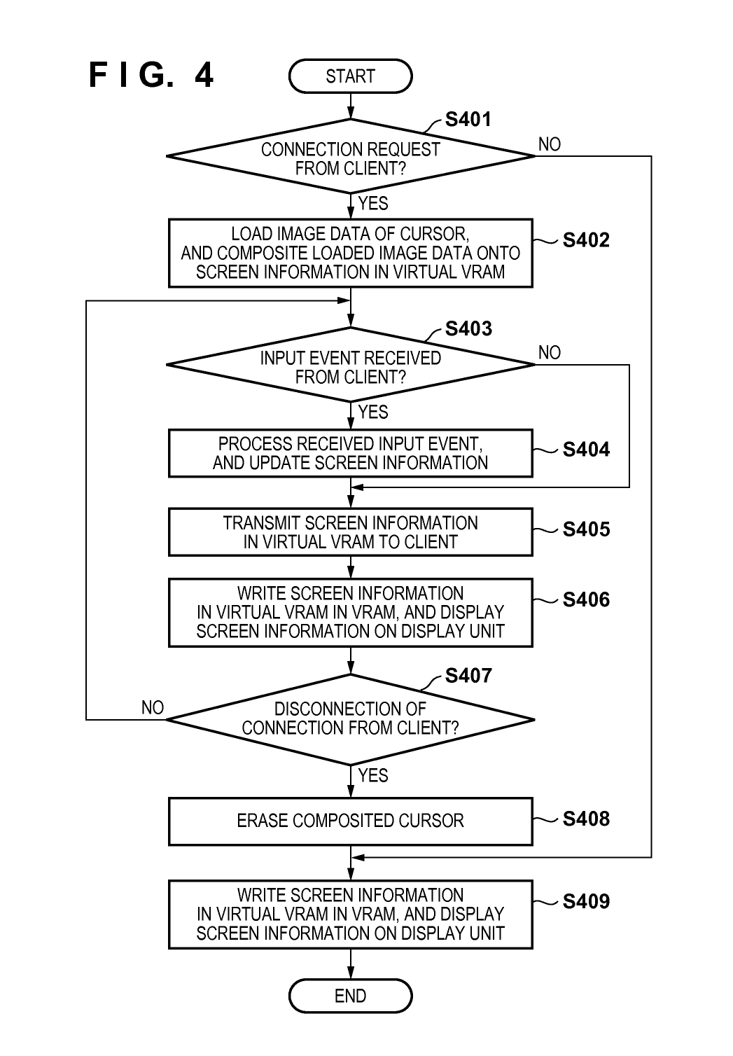

FIG. 4 is a flowchart for describing processing of the image processing apparatus 101 according to the embodiment of the present invention. With this processing, when the image processing apparatus 101 distributes screen information to the client terminal 103, the image processing apparatus 101 composites a cursor onto the screen information, and displays the composite screen information on the console unit 210. Respective steps shown in the flowchart of FIG. 4 are implemented when the CPU 201 of the image processing apparatus 101 reads out control programs stored in the ROM 202 or HDD 205 onto the RAM 203 and executes the programs.

This processing is started in response to an input event from the client terminal 103. The CPU 201 determines in step S401 whether or not a VNC connection request is received from the client terminal 103. If the CPU 201 determines that the VNC connection request is received from the client terminal 103, the process advances to step S402; otherwise, the process jumps to step S409.

In step S402, the CPU 201 writes image data of a cursor stored in the ROM 202 or HDD 205 in the RAM 203. Then, the CPU 201 composites the image data of the cursor onto screen information held in the virtual VRAM area of the RAM 203, and stores the composite screen information in the virtual VRAM area. The process then advances to step S403, and the CPU 201 determines whether or not an input event transmitted from the client terminal 103 is received. More specifically, the input event receiver 301 determines whether or not an input event signal transmitted from the client terminal 103 via the LAN 102 is received. For example, when a click or move operation by means of a pointing device is made on the client terminal 103, the client terminal 103 transmits designated coordinates as an input event to the image processing apparatus 101 together with information of the click or move operation. Then, the image processing apparatus 101 receives the input event. If the CPU 201 determines in step S403 that an input event from the client terminal 103 is received, the process advances to step S404; otherwise, the process jumps to step S405.

In step S404, the CPU 201 processes the received input event to update the screen information. More specifically, the input event generator 302 generates an input event signal for the image processing apparatus 101 based on the received input event signal, and sends the input event signal to the image data generator 303. Then, the image data generator 303 generates screen information which reflects the contents after execution of the input event, and holds the screen information in the virtual VRAM area of the RAM 203. For example, when the received input event is a move operation of the pointing device of the client terminal 103, the image data generator 303 generates screen information by changing the position of the cursor (moving the cursor) based on the received coordinates together with the information of the move operation.

Next, the process advances to step S405, and the CPU 201 transmits the screen information held in the virtual VRAM area of the RAM 203 to the client terminal 103. Then, the client terminal 103 holds the received screen information, and displays it on its display unit. The process then advances to step S406, and the CPU 201 writes the screen information held in the virtual VRAM area of the RAM 203 in the VRAM 204 and displays it on the display unit of the console unit 210 via the console unit I/F 206. In this case, in step S402, since the data obtained by compositing the cursor on the screen information is stored in the virtual VRAM area, the CPU 201 displays the screen composited with the cursor.

Next, the process advances to step S407, and the CPU 201 determines whether or not the VNC connection with the client terminal 103 is disconnected. If the CPU 201 determines that the VNC connection to the client terminal 103 is disconnected, the process advances to step S408. If the CPU 201 determines that the VNC connection to the client terminal 103 is not disconnected, the process returns to step S403. In step S408, the CPU 201 deletes the cursor composited onto the screen information. More specifically, the CPU 201 erases the image data of the cursor loaded onto the RAM 203 in step S402. Then, the process advances to step S409, and the CPU 201 writes the screen information held in the virtual VRAM area of the RAM 203 in the VRAM 204 and displays it on the display unit of the console unit 210 via the console unit I/F 206. In step S409, since the screen information is stored in the virtual VRAM area without being composited with the cursor, the CPU 201 displays the screen without displaying any cursor.

By executing such processing, the screen information including the cursor can be transmitted to the client terminal 103 and can be displayed on the screen of the client terminal. Thus, for the user of the image processing apparatus 101 which does not display any cursor, an operation method, setting method, or the like of the apparatus can be explained while showing an operation trace using the cursor from the client terminal 103.

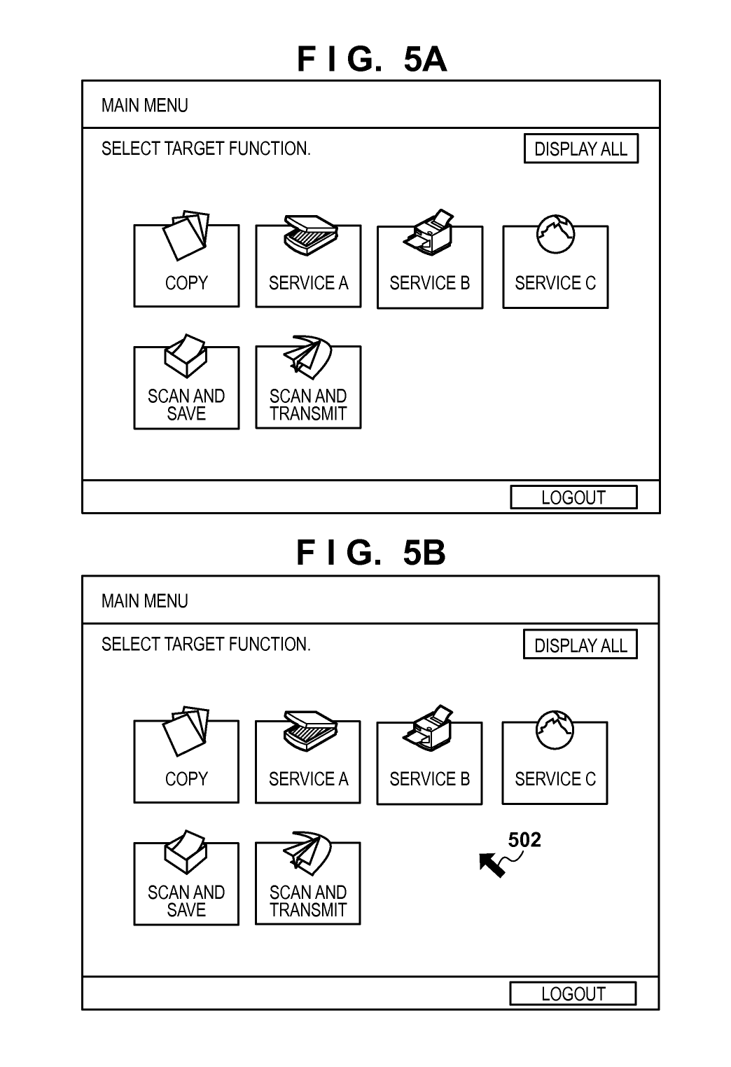

FIGS. 5A and 5B depict views showing examples of main menu screens displayed on the display unit of the console unit 210 based on screen information stored in the image processing apparatus 101 according to this embodiment.

FIG. 5A shows an example of a main menu screen displayed on the console unit 210 when the image processing apparatus 101 is not connected to the client terminal 103. That is, FIG. 5A shows a state in which screen information is output to the console unit 210 in step S409 in FIG. 4. This screen is used to allow the user to select and instruct various functions of the image processing apparatus 101. In this state, when an operation procedure is to be explained from a remote call center, since it is difficult for the user to recognize which button is pressed to make an operation, the operation procedure may not often be correctly taught.

By contrast, FIG. 5B shows an example of a main menu screen displayed on the console unit 210 when the image processing apparatus 101 is VNC-connected to the client terminal 103. That is, FIG. 5B shows a state in which the screen information is displayed on the display unit of the console unit 210 in step S406 in FIG. 4. A cursor 502 is an object which moves in response to an input event from the client terminal 103.

Thus, when the operation procedure of the image processing apparatus 101 is to be explained from a remote call center (client terminal), a trace of an operation by an operator of the call center is displayed on the display unit of the image processing apparatus 101 via the cursor 502. For this reason, it is easy for the user of the image processing apparatus 101 to understand the operation procedure, and the operation procedure can be correctly taught.

Note that this embodiment has explained the case in which when the image processing apparatus 101 (first information processing apparatus) is connected to the client terminal 103 (second information processing apparatus), the cursor 502 is displayed on the image processing apparatus 101. However, it may be set to inhibit the image processing apparatus 101 from displaying the cursor 502 when the image processing apparatus 101 is connected to the client terminal 103. Also, for example, the image processing apparatus 101 or client terminal 103 may prompt the user to select whether or not to display the cursor in a VNC connection mode.

Furthermore, whether or not to display the cursor may be set by the client terminal 103 or the image processing apparatus 101.

Moreover, a mouse cursor may be displayed in the VNC connection mode, but it may be inhibited from being displayed in a specific mode such as S-Mode.

This embodiment has explained the case in which when the image processing apparatus 101 is VNC-connected to the client terminal 103, the image processing apparatus 101 always displays the cursor 502. However, for example, the cursor may be inhibited from being displayed on a specific screen. For example, as for a setting screen, an operation method of which is not to be presented to the user, the user need not understand the operation method without displaying the cursor.

As described above, according to this embodiment, even in an image processing apparatus which does not always display a cursor, an operation method, setting method, or the like of that image processing apparatus can be explained while showing an operation trace using a cursor for the user of the image processing apparatus. Thus, the user of the image processing apparatus is able to more easily understand the explanation, thus improving the operation support efficiency in the image processing apparatus.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such changes and equivalent structures and functions.

This application claims the benefit of Japanese Patent Application No. 2013-020830, filed Feb. 5, 2013, which is hereby incorporated by reference herein in its entirety.

What is claimed is:

1. An image processing apparatus being capable of transmitting image data of a screen displayed on a display unit of the image processing apparatus to an information processing apparatus with a Virtual Network Computing (VNC), the apparatus comprising:
a connection unit configured to establish a connection with the information processing apparatus with the VNC;
a composite unit configured to combine a cursor image with image data of the screen being displayed on the display unit in a case that the connection unit has established the connection with the information processing apparatus;
a reception unit configured to receive an input event that is transmitted from the information processing apparatus in response to an operation of a pointing device on the information processing apparatus; and
an updating unit configured to update image data, in which the cursor image is combined, that is being displayed on the screen based on the event received by the reception unit.

2. The image processing apparatus according to claim 1, further comprising an erasing unit configured to erase the cursor image displayed on the screen of the display unit in a case that the connection with the information processing apparatus with the VNC is disconnected.

3. The image processing apparatus according to claim 1, further comprising a transmission unit configured to transmit image data updated by the updating unit to the information processing apparatus.

4. The image processing apparatus according to claim 1, wherein the updating unit updates the image data in which the cursor image is combined so as to move a cursor on the screen in accordance with coordinates information, in a case that the event received by the reception unit includes the coordinates information indicating a movement of the pointing device.

5. The image processing apparatus according to claim 1, further comprising a printing unit, wherein the information processing apparatus is a support device for supporting an operation of an operator of the image processing apparatus.

6. A method of controlling an image processing apparatus being capable of transmitting image data of a screen displayed on a display unit of the image processing apparatus to an information processing apparatus with a Virtual Network Computing (VNC), the method comprising:
establishing a connection with the information processing apparatus with the VNC;
combining a cursor image with image data of the screen being displayed on the display unit in a case that the connection with the information processing apparatus has been established;
receiving an input event that is transmitted from the information processing apparatus in response to an operation of a pointing device on the information processing apparatus; and
updating image data, in which the cursor image is combined, that is being displayed on the screen based on the event received in the receiving step.

7. A non-transitory computer readable storage medium storing a program for causing a computer to execute a method of controlling an image processing apparatus being capable of transmitting image data of a screen displayed on a display unit of the image processing apparatus to an information processing apparatus with a Virtual Network Computing (VNC), the method comprising:
establishing a connection with the information processing apparatus with the VNC;
combining a cursor image with image data of the screen being displayed on the display unit in a case that the connection with the information processing apparatus has been established;
receiving an input event that is transmitted from the information processing apparatus in response to an operation of a pointing device on the information processing apparatus; and
updating image data, in which the cursor image is combined, that is being displayed on the screen based on the event received in the receiving step.
